(19) United States
(12) Patent Application Publication
(10) Pub. No.: US 2025/0219121 A1
(43) Pub. Date: Jul. 3, 2025

(54) A METAL ELECTRODE SYSTEM FOR ELECTROCHEMICAL CELLS

(71) Applicant: National University of Singapore, Singapore (SG)

(72) Inventors: Qing Wang, Singapore (SG); Shiqiang Huang, Singapore (SG)

(73) Assignee: National University of Singapore, Singapore (SG)

(21) Appl. No.: 18/850,461

(22) PCT Filed: Mar. 24, 2023
(86) PCT No.: PCT/SG2023/050195

§ 371 Date: Sep. 24, 2024

(30) Foreign Application Priority Data
Mar. 24, 2022 (SG) 10202203038U

(51) Int. Cl. H01M 8/18; H01M 4/96

(52) U.S. Cl. CPC H01M 8/188; H01M 4/96; H01M 2300/0002

(57) ABSTRACT

Provided herein is a redox flow battery, comprising:
a catholyte compartment, comprising a catholyte, and a cathode;
an anolyte compartment, comprising an anolyte, and an anode comprising a first metal; and
an ion selective membrane disposed between the cathode compartment and anode compartment,
   wherein:
the first metal is selected from the group consisting of an alkali metal, an alkaline earth metal, a Group III metal, and a transition metal;
the anolyte comprises an anodic redox mediator; and
the anodic redox mediator has a redox potential versus a standard hydrogen electrode that is more positive than a redox potential of the first metal versus a standard hydrogen electrode.

### FIELD OF INVENTION

The invention relates to a redox flow battery, to an electrolyte suitable for use in a redox flow battery, and to a kit comprising a catholyte and an anolyte, which kit is suitable for use in a redox flow battery.

### BACKGROUND

The listing or discussion of a prior-published document in this specification should not necessarily be taken as an acknowledgement that the document is part of the state of the art or is common general knowledge.

Energy utilization is essential to humanity and vitalizes the grand societal development. However, the fossil fuels-dominated energy structure has encountered major issues for sustainable development. Hence, the exploitation of green and renewable energies such as wind and solar power, as a consensus, has been widely implemented across the globe. However, these renewable energy sources are commonly intermittent and unpredictable, from which the produced electricity fluctuates and imposes impact on the safe and stable operation of power grids, resulting in undesired curtailment. In response, electrochemical energy storage (EES) technology has emerged as an important means to address this issue. Among the numerous EES technologies, aqueous redox flow batteries (ARFB) have been regarded as one of the most promising ones for large-scale energy storage due to the salient features of high safety, decoupled energy storage and power generation, and good scalability. Vanadium flow battery (VFB), one of the mature ARFB systems, has revealed great advantages in operation since it was first reported in 1985. However, the deployment of VFBs confronts challenges of high cost, low energy density, corrosive electrolytes and mediocre thermal stability, which limit its widespread application.

Zinc-based flow batteries have drawn considerable attention due to low material cost, high cell voltage, earth abundance and low toxicity. However, with repeated stripping/plating reactions of the zinc anode, zinc dendrites commonly form, owing to inhomogeneous reactions. The growth of dendrites becomes more severe at higher current densities and areal capacities, and some dendrites may fall off from the electrode and turn into “dead zinc”, resulting in irreversible capacity loss, particularly at deep discharge conditions. To eliminate the “dead zinc” and capacity loss, most studies have focused on preventing the formation of dendrites through a uniform plating/stripping process of the zinc, such as by introducing additives into the electrolyte, optimizing electrode structure and designing advanced membranes, and etc. While these strategies have shown good improvement in battery stability and cycling life, accumulation of “dead zinc” and irreversible capacity loss remain. As a result, the batteries generally operate with limited capacity and at relatively low depth of discharge (DOD)/charge.

Therefore, there exists a need for new zinc-based flow batteries to overcome at least one of the aforementioned problems.

### SUMMARY OF INVENTION

The inventors have surprisingly found that the inclusion of a redox mediator in the anolyte can reverse the accumulation of “dead zinc”, and avoid irreversible capacity loss in a redox flow battery. Thus, the invention provides the following.

1. A redox flow battery, comprising:
a catholyte compartment, comprising a catholyte, and a cathode;
an anolyte compartment, comprising an anolyte, and an anode comprising a first metal; and
an ion selective membrane disposed between the cathode compartment and anode compartment,
wherein:
the first metal is selected from the group consisting of an alkali metal, an alkaline earth metal, a Group III metal, and a transition metal;
the anolyte comprises an anodic redox mediator; and
the anodic redox mediator has a redox potential versus a standard hydrogen electrode that is more positive than a redox potential of the first metal versus a standard hydrogen electrode.

2. The redox flow battery according to Clause 1, wherein the anodic redox mediator is selected from one or more of the group consisting of a phenazine redox mediator, a quinone redox mediator, a viologen redox mediator, a ferrocene derivative, an nitroxide radical redox mediator, and an alloxazine redox mediator;
optionally wherein the anodic redox mediator is selected from one or more of the group consisting of 7,8-dihydroxy-2-phenazinesulfonic acid (DHPS), an amino-acid functionalised phenazine, dihydroxyanthraquinone or a derivative thereof, a sulfonated ferrocene, and alloxazine 7/8-carboxylic acid,
more optionally wherein the anodic redox mediator is selected from one or more of the group consisting of DHPS, and a sulfonated ferrocene.

3. The redox flow battery according to Clause 1, wherein the catholyte further comprises a cathodic redox mediator.

4. The redox flow battery according to Clause 3, wherein the cathodic redox mediator comprises one or more of the following pairs:
[Fe(CN)₆]³⁻/[Fe(CN₆)]⁴⁻;
O₂/OH⁻;
I₃⁻/I⁻;
Br₂/Br⁻;
(I⁻, Br⁻/I₃⁻, I₂Br⁻);
Fe³⁺/Fe²⁺;
(2,2,6,6-Tetramethylpiperidin-1-yl)oxyl (TEMPO) derivatives; and
MnO₂/Mn²⁺.

5. The redox flow battery according to Clause 3 or Clause 4, wherein the concentration of the cathodic redox mediator in the catholyte is at least 0.3 M, such as at least 0.5 M, such as at least 1 M.

6. The redox flow battery according to any one of the preceding clauses, wherein the catholyte comprises a salt of the first metal, optionally wherein the salt of the first metal is an oxide or hydroxide of the first metal.

7. The redox flow battery according to any one of the preceding clauses, wherein the concentration of the anodic redox mediator in the anolyte is from 0.001 M to 1 M,
optionally from 0.01 M to 0.05 M,
more optionally from 0.015 M to 0.035 M,
such as from 0.02 M to 0.03 M.

8. The redox flow battery according to any one of the preceding clauses, wherein:
(a) the catholyte and anolyte each comprise an inorganic base; or
(b) the catholyte and anolyte each comprise a neutral metal salt.

9. The redox flow battery according to Clause 8 or 9, wherein:
(a) the catholyte and anolyte each comprise an inorganic base, and the anodic redox mediator is DHPS; or
(b) the catholyte and anolyte each comprise a neutral metal salt, and the anodic redox mediator is a sulfonated ferrocene.

10. The redox flow battery according to Clause 8 or 9, wherein:
(a) the inorganic base is selected from one or more of NaOH, LiOH and KOH;
(b) the neutral metal salt is selected from one or more of the group consisting of MCl, MBr, M₂SO₄, MNO₃, where M is selected from Li, Na, K and NH₄.

11. The redox flow battery according to any one of the preceding clauses, wherein the first metal is selected from the group consisting of an alkali metal, an alkaline earth metal, aluminium, zinc, and iron;
optionally wherein the first metal is selected from the group consisting of lithium potassium, sodium, magnesium, aluminium, zinc, and iron.

12. The redox flow battery according to any one of the preceding clauses, wherein the first metal is Zn.

13. The redox flow battery according to Clause 12, wherein an areal capacity of zinc in the redox flow battery is from 10 mAh/cm² to 450 mAh/cm², such as from 10 mAh/cm² to 300 mAh/cm², such as from 12 mAh/cm² to 250 mAh/cm², such as from 12.2 mAh/cm² to 250 mAh/cm².

14. The redox flow battery according to any one of the preceding clauses, wherein the anode comprises carbon and the first metal, optionally wherein the anode comprises carbon fibres and the first metal.

15. The redox flow battery according to any one of the preceding clauses, wherein a current density of the redox flow battery is from 10 mA/cm² to 300 mA/cm², such as from 10 mA/cm² to 200 mA/cm², such as from 10 mA/cm² to 100 mA/cm², such as from 20 mA/cm² to 80 mA/cm².

16. The redox flow battery according to any one of the preceding clauses, wherein a discharge capacity of the redox flow battery is from 10 mAh/cm² to 450 mAh/cm², such as from 10 mAh/cm² to 300 mAh/cm², such as from 12 mAh/cm² to 250 mAh/cm², such as from 12.2 mAh/cm² to 250 mAh/cm².

17. The redox flow battery according to any one of the preceding clauses, wherein a capacity fading rate of the redox flow battery is less than 0.02%/day over at least 1500 hours.

18. The redox flow battery according to any one of the preceding clauses, wherein the catholyte and anolyte are aqueous.

19. The redox flow battery according to any one of the preceding clauses, wherein:
the anodic redox mediator comprises DHPS;
the catholyte comprises one or both of [Fe(CN)₆]³⁻ and [Fe(CN₆)]⁴⁻;
the first metal comprises Zn;
the catholyte and anolyte each comprise an inorganic base (e.g. NaOH); and
the catholyte comprises an oxide or hydroxide of zinc.

20. The redox flow battery according to any one of Clauses 1 to 18, wherein:
the anodic redox mediator comprises a sulfonated ferrocene;
the catholyte comprises one or both of I⁻ and I₂Br⁻.
the first metal comprises Zn;
the catholyte and anolyte each comprise a neutral metal salt (e.g. NaCl, KBr and/or KCl); and
the catholyte comprises an neutral zinc salt (e.g. ZnCl₂, ZnBr₂, and/or ZnI₂).

21. The redox flow battery according to Clause 19 or 20, wherein the catholyte and anolyte are aqueous.

22. An electrolyte suitable for use in a redox flow battery comprising:
a solvent (e.g. water);
a neutral or basic metal salt; and
a redox mediator selected from one or more of the group consisting of DHPS, and a sulfonated ferrocene.

23. The electrolyte according to Clause 22, wherein:
the metal salt comprises an oxide or hydroxide of zinc; and
the redox mediator is DHPS.

24. The electrolyte according to Clause 22 or 23, further comprising an inorganic base, optionally wherein the inorganic base comprises NaOH.

25. A kit comprising:
(i) a catholyte comprising:
an oxide or hydroxide of a first metal, and
a neutral or basic metal salt; and
(ii) an anolyte comprising:
a redox mediator having a redox potential versus a standard hydrogen electrode that is more positive than a redox potential of the first metal versus a standard hydrogen electrode, and the neutral or basic metal salt.

26. The kit according to Clause 25, wherein:
the first metal is zinc;
the neutral or basic metal salt is selected from NaCl and NaOH;
the redox mediator is selected from one or more of the group consisting of DHPS, and a sulfonated ferrocene,
provided that when the metal salt is NaCl, the redox mediator is a sulfonated ferrocene, and when the metal salt is NaOH, the redox mediator is DHPS.

### BRIEF DESCRIPTION OF THE DRAWINGS

FIG. 1 depicts a conceptual illustration of revitalization of the “dead zinc” from the anode through a redox-mediated re-activation process. Upon repeated plating/stripping, the “dead zinc” falls off from carbon felt matrix and loses electrical contact with the electrode. During the discharge process, after the “active zinc” on electrode is depleted, soluble redox mediator (RM) dissolved in the electrolyte further oxidizes the “dead zinc” and ferries electrons to the electrode through a redox-targeting process.

FIG. 2 depicts the CV curves of 50 mM [Zn(OH)₄]²⁻/3.8 M NaOH and 5 mM DHPS/3.8 M NaOH. Working electrode: glassy carbon disk; scan rate: 0.05 V/s.

FIG. 3 depicts the CV curves for 5 mM Fc-SO₃Na/1 M NaCl and 0.1 M ZnCl₂/1 M NaCl solution on the glassy carbon electrode, the scanning rate was 0.05 V/s.

FIG. 4 depicts the four-electrode measurement of the various potential differences of a DHPS/[Fe(CN)₆]³⁻/4-flow cell at a current density of 30 mA/cm². As shown in the figure, the ΔV⁺ and ΔV⁻ between charge and discharge processes are almost negligible and the main resistance is from membrane and other series resistance of the device.

FIG. 5 depicts (a) cycling performance of two zinc-based symmetric flow cells with an areal capacity of 12.2 mAh/cm² with/without 20 mM DHPS in anolyte at 20 mA/cm². (b) Representative voltage profiles of the cell in (a) with DHPS in anolyte. (c) Cycling performance of a zinc-based symmetric flow cell with an areal capacity of 92 mAh/cm² with 20 mM DHPS in anolyte at 50 mA/cm². (d) Voltage profiles of cell in (c) at the 5th, 40th, 80th cycle.

FIG. 6 depicts (a) cycling performance from 120 to 175 cycles of two zinc-based symmetric cells with a zinc areal capacity of 12.2 mAh/cm² with/without DHPS in anolyte. The catholyte system was replaced at the 140th cycle. (b) Voltage profiles of the cell with DHPS at the 5th and 145th cycles. The current density was 20 mA/cm².

FIG. 7 depicts scanning electron microscopy (SEM) images of (a) the pristine carbon felt electrode and the electrode (b) without and (c) with DHPS after 175 cycles (discharge state) at 12.2 mAh/cm² under 20 mA/cm².

FIG. 8 depicts X-ray diffraction (XRD) patterns of the pristine carbon felt electrode and the electrodes after testing for 175 cycles (discharged state) at 20 mA/cm² without and with DHPS in anolyte. The areal capacity of zinc in the cells was 12.2 mAh/cm².

FIG. 9 depicts cumulative discharge capacity of DHPS-mediated zinc symmetric flow battery undergone 78 cycles (3rd to 80th cycle) of continuous testing (around 11.9 days) at a current density of 50 mA/cm². The theoretical capacity was calculated based on the areal discharge capacity (0.0912 Ah/cm²) in the 3rd cycle as the first two cycles had a capacity increase (see in FIG. 11c), presumably a result of the activation of ZnO passivation layer on zinc plate.

FIG. 10 depicts SEM images of carbon felt electrode with DHPS in anolyte after 80 cycles (discharge state) at 92 mAh/cm² under 50 mA/cm².

FIG. 11 depicts XRD pattern of the carbon felt electrode with DHPS in anolyte after 80 cycles (discharge state) at 92 mAh/cm² under 50 mA/cm².

FIG. 12 depicts the galvanostatic cycling performance of zinc based symmetric flow battery with Fc-SO₃Na in anolyte under the neutral condition: the catholyte was 1 M ZnCl₂ (80 mL) and anolyte was 20 mM Fc-SO₃Na/1 M ZnCl₂ (20 mL). The current density was 20 mA/cm². The zinc used were 0.2 g and 2 g for anode and cathode, respectively.

FIG. 13 depicts a summary of RMs for redox-mediated zinc anode for redox flow batteries application.

FIG. 14 depicts (a) cycling performance of an alkaline zinc-iron flow battery (AZIFB) with an areal Zn capacity of 152 mAh/cm² and 30 mM DHPS in anolyte under 50 mA/cm². 110 mL and 300 mL 3.8 M OH⁻ with 30 mM DHPS and 0.6 M Fe(CN)₆³⁻/0.05 M Fe(CN)₆⁴⁻/1.8 M OH⁻ were used as anolyte and catholyte, respectively. The zinc used for anode was 2.5 g. (b) Cumulative areal discharge capacity of the above AZIFB undergone 247 cycles of continuous tests for more than 2 months. (c) Galvanostatic voltage profiles of the above AZIFB in the 10th, 150th, and 200th cycle. The current density was 50 mA/cm².

FIG. 15 depicts the cycling performance of an AZIFB with 92 mAh/cm² of zinc loading in the absence of DHPS in the anolyte. The current density was 20 mA/cm².

FIG. 16 depicts (a) SEM image of the carbon felt electrode from a redox-mediated AZIFB after 248 cycles (discharge state) at 152 mAh/cm² under 50 mA/cm². (b) Energy dispersive spectrometry (EDS) mapping for C element. (c) Energy-dispersive X-ray (EDX) spectrum of carbon felt. No zinc was detected from the EDX measurement.

FIG. 17 depicts the XRD pattern of the carbon felt electrode from a redox-mediated AZIFB after 248 cycles (discharge state) at 152 mAh/cm² under 50 mA/cm².

FIG. 18 depicts the SEM images of the carbon felt electrode surface after charging to an areal capacity of 152 mAh/cm² at 50 mA/cm². (a,c) without DHPS and (b,d) with DHPS in anolyte.

FIG. 19 depicts the SEM images of the cross section of the carbon felt electrode after charging to an areal capacity of 152 mAh/cm² at 50 mA/cm². (a,c) without DHPS and (b,d) with DHPS in anolyte.

FIG. 20 depicts the cycling performance of an AZIFB with an areal zinc capacity of 200 mAh/cm² and 30 mM DHPS in anolyte at 80 mA/cm².

FIG. 21 depicts the cycling performance of an AZIFB with an areal zinc capacity of 250 mAh/cm² and 30 mM DHPS in anolyte at 80 mA/cm².

FIG. 22 depicts the solubility test of ZnO in 3.8 M NaOH. It was tested by dissolving ZnO into 15 mL 3.8 M NaOH solution until reaching saturated state. The solubility was around 0.5 M.

### DESCRIPTION

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The invention provides a redox flow battery, comprising:
a catholyte compartment, comprising a catholyte, and a cathode;
an anolyte compartment, comprising an anolyte, and an anode comprising a first metal; and
an ion selective membrane disposed between the cathode compartment and anode compartment,
   wherein:
the first metal is selected from the group consisting of an alkali metal, an alkaline earth metal, a Group III metal, and a transition metal;
the anolyte comprises an anodic redox mediator; and
the anodic redox mediator has a redox potential versus a standard hydrogen electrode that is more positive than a redox potential of the first metal versus a standard hydrogen electrode.

The ion selective membrane divides the cathode compartment from the anode compartment. It can be an electro-active charge balancing ion conducting membrane (e.g., a potassium, lithium or sodium ion conducting membrane). The ion selective membrane prevents cross-diffusion of the redox mediator(s) and allows for movement of electro-active charge balancing ions (e.g., potassium, lithium ions, sodium ions, magnesium ions, aluminium ions, copper ions, protons, or a combination thereof). For example, the separator may be a Nafion™ membrane, a lithium phosphorus oxynitride glass, a lithium thiophosphate glass, sodium phosphorus oxynitride glass, a sodium thiophosphate glass, a NASICON-type lithium conducting glass ceramic, a NASICON-type sodium conducting glass ceramic, a Garnet-type lithium or sodium conducting glass ceramic, a ceramic nanofiltration membrane, a lithium or sodium ion-exchange membrane, or suitable combinations thereof.

Both the cathode and anode compartments contain electrodes (i.e. the cathode and anode), which electrodes may comprise a carbon, a metal, or a combination thereof, provided that the anode comprises a first metal (which first metal may be present in addition to a carbon). Preferably, these two electrodes have high surface area, with or without one or more catalysts, to facilitate the charge collection process. They can be made of a carbon, a metal, or a combination thereof. Examples of an electrode can be found in Skyllas-Kazacos, et. al., Journal of The Electrochemical Society, 158, R55-79 (2011) and Weber, et. al., Journal of Applied Electrochemistry, 41, 1137-64 (2011).

In some embodiments of the invention that may be mentioned herein, the anode may comprise a carbon and the first metal. For example, the anode may comprise carbon fibres and the first metal.

The catholyte and anolyte each comprise a supporting electrolyte, which may comprise a solvent and one or more compounds or salts that provide ions, as discussed further herein.

A suitable solvent for use in the supporting electrolyte is water, which may be used alone or in combination with an organic solvent suitable for use in a battery. Organic solvent can be used as additives to tune the standard potential of active materials. Suitable organic solvents that may be mentioned herein include, but are not limited to an alcohol, a carbonate, an ether, an ester, a ketone, and a nitrile.

Suitable alcohols that may be mentioned herein include, but are not limited to methanol, ethanol, n-propanol, iso-propanol and the like. Suitable carbonates include cyclic carbonates (such as propylene carbonate, ethylene carbonate, diethyl carbonate butylene carbonate, fluoroethylene carbonate, chloroethylene carbonate, vinylene carbonate, and/or the like), and a linear carbonate (such as dimethyl carbonate, diethyl carbonate, ethylmethyl carbonate, and the like). Suitable ethers include glyme solvent and cyclic or linear ethers other than a glyme (such as tetrahydrofuran (and derivatives thereof), 1,3-dioxane, 1,4-dioxane, 1,2-dimethoxy ethane, 1,4-dibutoxyethane, and the like). Suitable esters include linear esters (such as methyl formate, methyl acetate, methyl butyrate, and the like). Suitable nitriles include, but are not limited to acetonitrile, benzonitrile, and the like. Further solvents that may be mentioned include dioxolane or a derivative thereof, ethylene sulfide, sulfolane, and sultone or a derivative thereof.

Suitable glyme solvents may be selected from one or more of the group consisting of ethylene glycol dimetheyl ether (monoglyme), diglyme, triglyme, tetraglyme, methyl nonafluorobutyl ether (MFE) and analogues thereof. Analogues of tetraglyme (CH₃(O(CH₂)₂)₄OCH₃) that may be mentioned include, but are not limited to, compounds where one or both of its CH₃ end members may be modified to either —C₂H₅ or to —CH₂CH₂Cl, or other similar substitutions. In certain embodiments of the invention that may be mentioned herein, the glyme solvent is tetraglyme.

As will be appreciated, water may be used in the systems described herein as part of the supporting electrolyte. In other words, the catholyte and anolyte may be aqueous. When water is used, it may be the only solvent, or organic solvents may be used as additive solvents in any suitable weight ratio with respect to water. For example, the additional solvents may be selected from one or more of the group selected from propylene carbonate, ethylene carbonate, diethyl carbonate, dimethyl carbonate, ethyl methyl carbonate, tetrahydrofuran, sulfolane, acetonitrile and tetraglyme.

Alternatively, the systems described herein may be non-aqueous. That is, the anolyte and catholyte may comprise only organic solvents and not comprise water. In such cases, the organic solvents may be selected from one or more of the group selected from propylene carbonate, ethylene carbonate, diethyl carbonate, dimethyl carbonate, ethyl methyl carbonate, tetrahydrofuran, sulfolane, acetonitrile and tetraglyme.

In particular embodiments that may be mentioned herein the solvent used in the catholyte and anolyte may be water alone or water in combination with a glyme solvent (e.g. water and tetraglyme).

As noted above, the anolyte comprises an anodic redox mediator. As used herein, the term “redox mediator” refers to a compound present (e.g., dissolved) in the catholyte or anolyte that acts as a molecular shuttle transporting charges during charging/discharging of the battery.

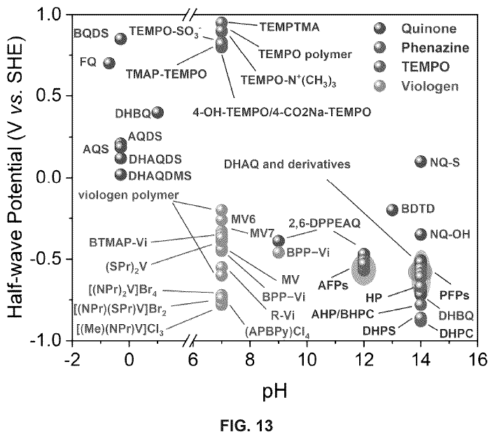

The anodic redox mediator has a redox potential versus a standard hydrogen electrode that is more positive than a redox potential of the first metal versus a standard hydrogen electrode. In other words, the anodic redox mediator is able to oxidise the first metal, such that any portion of deposited first metal that becomes separated from the anode, i.e. “dead metal”, may be oxidised by the anodic redox mediator and placed back into solution. As will be appreciated by a person skilled in the art, the nature of the anodic redox mediator is not particularly important provided that it is able to oxidise the first metal under the conditions (e.g. pH) of the anolyte. Examples of possible redox mediators are provided in FIG. 13, and a skilled person will easily be able to identify from this Figure which redox mediators would be suitable for use with any particular metal.

In some embodiments of the invention that may be mentioned herein, the anodic redox mediator may be selected from one or more of the group consisting of a phenazine redox mediator, a quinone redox mediator, a viologen redox mediator, a ferrocene derivative, an nitroxide radical redox mediator, and an alloxazine redox mediator. For example, the anodic redox mediator may be selected from one or more of the group consisting of DHPS, an amino-acid functionalised phenazine, dihydroxyanthraquinone or a derivative thereof, a sulfonated ferrocene, and alloxazine 7/8-carboxylic acid, such as selected from one or more of the group consisting of DHPS, and a sulfonated ferrocene.

A particular example of a sulfonated ferrocene that may be mentioned herein is ferrocene sulfonate, sodium salt.

The catholyte may comprise a cathodic redox mediator. Examples of suitable cathodic redox mediators include one or more of the following pairs [Fe(CN)₆]³⁻/[Fe(CN₆)]⁴⁻; O₂/OH⁻; MnO₄⁻/MnO₄²⁻; I₃⁻/I⁻; Br₂/Br⁻; (I⁻, Br⁻/I₃⁻, I₂Br⁻); Fe³⁺/Fe²⁺; (2,2,6,6-Tetramethylpiperidin-1-yl)oxyl (TEMPO) derivatives; and MnO₂/Mn²⁺.

Particular examples of cathodic redox mediators include [Fe(CN)₆]³⁻/[Fe(CN₆)]⁴⁻ and/or Br/Br₂.

In embodiments where the redox mediator comprises [Fe(CN)₆]³⁻/[Fe(CN₆)]⁴⁻, the [Fe(CN)₆]³⁻ redox mediator may be ferricyanide (M₄Fe(CN)₆) and the [Fe(CN₆)]⁴⁻ redox mediator may be ferrocyanide (M₄Fe(CN)₆), where in each case M is independently selected from the group consisting of Li, Na, K and NH₄, optionally wherein M is K.

In embodiments where the redox mediator comprises Br⁻/Br₂, the Br⁻ redox mediator may be MBr, where in each case M is independently selected from the group consisting of Li, Na, K and NH₄, optionally wherein M is K.

In certain embodiments that may be described herein, the supporting electrolyte may further comprise a redox mediator in addition to the anodic/cathodic redox mediators described above. Said additive redox mediators may be selected from one or more of the group consisting of a Zn/Zn²⁺ redox mediator, Fe^{2+/3+}, a transition metal complex, a metallocene, a triaryl amine, a phenothiazine derivative, a phenoxazine derivative, a carbazole derivative, an aromatic derivative, a nitroxide radical, a disulfide, polysulfides, viologens, quinone derivatives, ferrocene (C₁₀H₁₀Fe) and derivatives thereof, iodide (MI) and bromide (MBr), where in each case M is independently selected from the group consisting of Li, Na, K and NH₄. In more particular embodiments that may be mentioned herein, said additive redox mediators may be selected from one or more of the group consisting of a Zn/Zn²⁺ redox mediator, Fe^{2+/3+}, ferroin, iron (II/III) tris(2,2′-bipyridine), iron (II/III) tris(2,2′-methylbipyridine), iron (II/III) tris(2,2′-methoxybipyridine), viologens, quinone derivatives, ferrocene (C₁₀H₁₀Fe) and derivatives thereof, iodide (MI) and bromide (MBr), where in each case M is independently selected from the group consisting of Li, Na, K and NH₄.

Examples of the various redox mediators that may be used in the invention (whether as the anodic, cathodic or additive redox mediators mentioned above), are discussed below.

Examples of Zn/Zn²⁺ redox mediators that may be mentioned herein include, but are not limited to Zn/Zn(OH)₄²⁻, H₆ZnW₁₂O₄₀, and zinc porphyrin dyes.

Derivatives of ferrocene that may be mentioned herein include ferrocene derivatives having the structure:

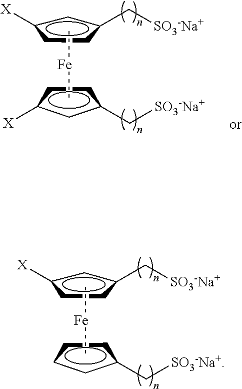

In the above formulae, X is selected from H, F, Cl, Br, I, NO₂, COOR, C₁₋₂₀ alkyl, CF₃, and COR, in which R is H or C₁₋₂₀ alkyl; n is from 0 to 20.

Specific derivatives of ferrocene that may be mentioned herein include but are not limited to bromoferrocene, ferrocenylmethyl dimethyl ethyl ammonium bis(trifluoromethanesulfonyl)imide (Fc1N112-TFSI), N-(pyridin-2-ylmethylene)-1-(2-(diphenylphosphino) ferrocenyl) ethanamine (FeCp₂PPh₂RCN), 1,1-dimethylferrocene (DMFc), tetraferrocene, di(ethylsulfonic sodium) ferrocene (C₁₄H₁₆FeS₂O₆Na₂), and di(trimethanesulfonic sodium) ferrocene (C₁₆H₂₂FeS₂O₆Na₂).

In particular embodiments of the invention that may be mentioned herein, the derivative of ferrocene may be di(trimethanesulfonic sodium) ferrocene (C₁₆H₂₂FeS₂O₆Na₂) or di(ethylsulfonic sodium) ferrocene (C₁₄H₁₆FeS₂O₆Na₂).

Viologens are 1,1′-disubstituted 4,4′-bipyridinium ions (where the nitrogen atoms of the pyridine rings are substituted by an alkyl group (e.g. C₁ to C₁₂ alkyl)), with a suitable counterion (e.g. Cl⁻, F⁻, Br⁻ and I⁻). An example of a viologen of this type is paraquat. When used herein viologens may include related compounds, such as diquat and bipolaron.

Further redox mediators that may be used in the current invention are described below with reference to WO 2013/012391, which is hereby incorporated by reference. The redox mediators mentioned in said document may be used in the currently disclosed battery system, which mediators are discussed below.

Metallocene derivatives used as redox mediators may have the following structure:

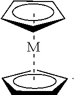

In the above formula, M can be Fe, Co, Ni, Cr. or V; each of the cyclopentadienyl rings, independently, can be substituted with one or more of the following groups: F, Cl, Br, I, NO₂, COOR, C₁₋₂₀ alkyl, CF₃, and COR, in which R can be H or C₁₋₂₀ alkyl.

Triarylamine derivatives used as redox mediators may have the following structure:

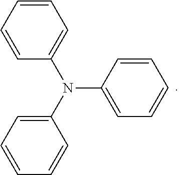 [SMILES: c1ccc(N(c2ccccc2)c2ccccc2)cc1]

In the above formula, each of the phenyl rings, independently, can be substituted with one or more of the following groups: F, Cl, Br, I, NO₂, COOR, C₁₋₂₀ alkyl, CF₃, and COR, in which R can be H or C₁₋₂₀ alkyl.

Phenothiazine derivatives and phenoxazine derivatives used redox mediators may have the following structure:

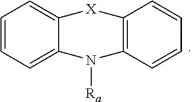

Rₐ can be H or C₁₋₂₀ alkyl, X can be O or S, each of the aromatic moieties is optionally substituted with one or more of the following groups: F, Cl, Br, I, NO₂, COOR, R, CF₃, and COR, in which R can be H or C₁₋₂₀ alkyl.

Carbazole derivatives used as redox mediators may have one of the following structures:

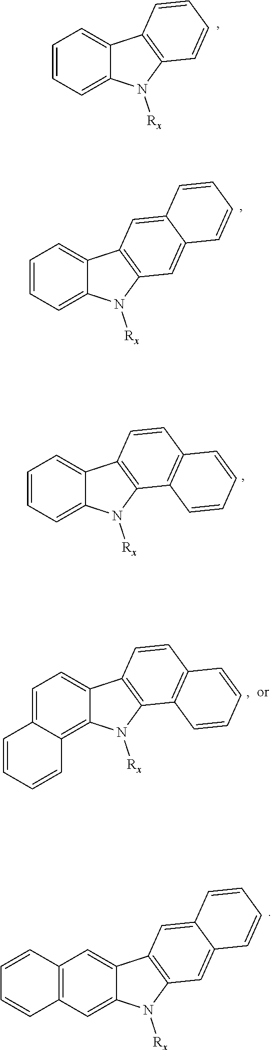

Rₓ can be H or C₁₋₂₀ alkyl and each of the aromatic moieties is optionally substituted with one or more of the following groups: F, Cl, Br, I, NO₂, COOR, C₁₋₂₀ alkyl, CF₃, and COR, in which R can be H or C₁₋₂₀ alkyl.

Transition metal complexes used as redox mediators may have one of the following structures:

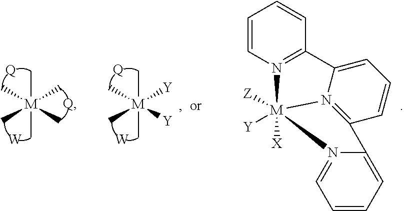

In the above formulae, M can be Co, Ni, Fe, Mn, Ru, or Os; each of the aromatic moieties is unsubstituted or is substituted with one or more of the following groups: F, Cl, Br, I, NO₂. COOR′, R′, CF₃, COR′, OR′, or NR′R″, each R′ and R″ can independently be H or C₁₋₂₀ alkyl; each of X, Y, and Z can independently be F, Cl, Br, I, NO₂, CN, NCSe, NCS, or NCO; and each Q and W can independently be selected from:

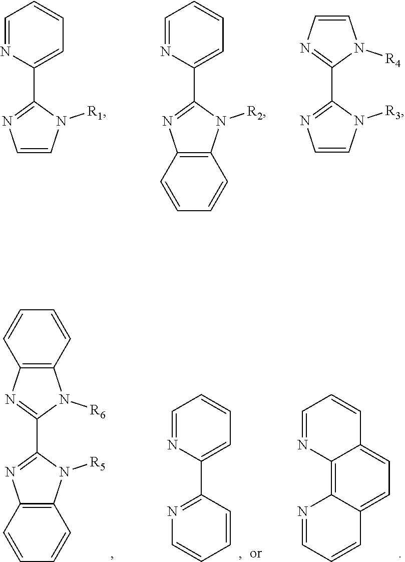

In these formulas, each of R₁, R₂, R₃, R₄, R₅, and R₆, can be F, Cl, Br, I, NO₂, COOR′, R′, CF₃, COR′, OR′, or NR′R″. Again, each of the aromatic moieties is optionally substituted with one or more of the following groups: F, Cl, Br, I, NO₂, COOR′, C₁₋₂₀ alkyl, CF₃, COR′, OR′, or NR′R″, in which each of R′ and R″, independently, can be H or C₁₋₂₀ alkyl. For the avoidance of doubt, the point of attachment of each Q and W to the metal is through the two nitrogen atoms present in each of the Q and W molecules above, thus Q and W act as bidentate ligands in the transition metal complex.

Specific transition metal complexes that may be mentioned herein include, but are not limited to, ferroin, iron (II/III) tris(2,2′-bipyridine), iron (II/III) tris(2,2′-methylbipyridine), and iron (II/III) tris(2,2′-methoxybipyridine).

Aromatic derivatives used as redox mediators may have the following structure:

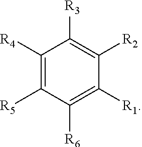

In these formulas, each of R₁, R₂, R₃, R₄, R₅, and R₆, can be C₁₋₂₀ alkyl, F, Cl, Br, I, NO₂, COOR′, CF₃, COR′, OR′, OP(OR′)(OR″), or NR′R″, in which each of R′ and R″, independently, can be H, C₁₋₂₀ alkyl.

Nitroxide radicals used as redox mediators may the following structure:

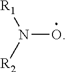

In these formulas, each of R₁ and R₂, independently, can be C₁₋₂₀ alkyl or aryl. R₁, R₂, and N together can form a heteroaryl, heteroaraalkyl, or heterocycloalkyl ring.

Disulfides used as redox mediators may the following structure:

R₁—S—S—R₂.

In these formulas, each of R₁ and R₂, independently, can be C₁₋₂₀ alkyl, COOR′, CF₃, COR′, OR′, or NR′R″, in which each of R′ and R″, independently, can be H or C₁₋₂₀ alkyl.

The anodic redox mediator, and where present, cathodic and additive redox mediators may be provided in any suitable concentration in the catholyte and anolyte. For example, in embodiments of the invention that may be mentioned herein, the total concentration of the redox mediator(s) present in the supporting electrolyte may be from 0.05 M to 8 M, such as from 0.05 to 2 M, such as from 0.1 M to 1.5 M, such as from 0.15 M to 1.0 M, such as from 0.25 M to 0.5 M in either the catholyte or anolyte.

Typically, the concentration of the cathodic redox mediator in the catholyte is at least 0.3 M, such as at least 0.5 M, such as at least 1 M. Typically, the concentration of the anodic redox mediator in the anolyte is from 0.001 M to 1 M, optionally from 0.01 M to 0.05 M, more optionally from 0.015 M to 0.035 M, such as from 0.02 M to 0.03 M.

As mentioned above, the supporting electrolyte comprises one or more compounds or salts that provide ions. Any suitable material may be used in this capacity.

Therefore, in some embodiments of the invention that may be mentioned herein, the catholyte and anolyte may each comprise an inorganic base. In alternative embodiments that may be mentioned herein, the catholyte and anolyte may each comprise a neutral metal salt.

Non-limiting examples of suitable ions that may be provided by the supporting electrolyte (e.g. by the inorganic base and/or neutral metal salt) include, but are not limited to carboxylic acids and salts formed from complementary ions. Suitable ions that may be mentioned herein include, but are not limited to ammonium ions, lithium ions, sodium ions, potassium ions, magnesium ions, aluminium ions, copper ions, chloride ions, bromide ions, nitrate ions, and hydroxide ions (e.g. ammonium ions, lithium ions, sodium ions, potassium ions, chloride ions, and hydroxide ions, optionally wherein the supporting electrolyte is formed from one or more of the group consisting of sodium ions, potassium ions, hydroxide ions and chloride ions).

In examples of such embodiments, the the catholyte and anolyte may each comprise an inorganic base, and the anodic redox mediator may be a redox mediator suitable for use in basic conditions, such as DHPS, a dihydroxyanthraquinone (a DHAQ), or alloxazine 7/8-carboxylic acid. Alternatively, the catholyte and anolyte may each comprise a neutral metal salt, and the anodic redox mediator may be a redox mediator suitable for use in neutral conditions, such as a sulfonated ferrocene, a viologen redox mediator, or amino acid-functionalized phenazine. A skilled person will understand that other redox mediators may be used in basic or neutral conditions, as discussed herein.

Examples of suitable inorganic bases that may be mentioned herein include one or more of NaOH, LiOH and KOH.

Examples of suitable neutral metal salts that may be mentioned herein include one or more of the group consisting of MCl, MBr, M₂SO₄, and MNO₃, where M is selected from Li, Na, K and NH₄.

The catholyte may further comprise a salt of the first metal, such as an oxide or hydroxide of the first metal.

As mentioned herein, the first metal is selected from the group consisting of an alkali metal, an alkaline earth metal, a Group III metal, and a transition metal. As explained above, the identity of the first metal is not particularly limited, provided it can be oxidised by the anodic redox mediator. In some embodiments of the invention that may be mentioned herein, the first metal may be selected from the group consisting of an alkali metal, an alkaline earth metal, aluminium, zinc, and iron. Examples of particular metals that may be useful as the first metal and may be mentioned herein include lithium potassium, sodium, magnesium, aluminium, zinc, and iron. In some particular embodiments of the invention, the first metal may be zinc.

When the first metal is zinc, the zinc may have an areal capacity of from 10 mAh/cm² to 450 mAh/cm², such as from 10 mAh/cm² to 300 mAh/cm², such as from 12 mAh/cm² to 250 mAh/cm², such as from 12.2 mAh/cm² to 250 mAh/cm².

Likewise, in some embodiments, the redox flow battery may have a discharge capacity of from 10 mAh/cm² to 450 mAh/cm², such as from 10 mAh/cm² to 300 mAh/cm², such as from 12 mAh/cm² to 250 mAh/cm², such as from 12.2 mAh/cm² to 250 mAh/cm².

In some embodiments of the invention, a current density of the redox flow battery may be from 10 mA/cm² to 300 mA/cm², such as from 10 mA/cm² to 200 mA/cm², such as from 10 mA/cm² to 100 mA/cm², such as from 20 mA/cm² to 80 mA/cm².

As discussed herein, the use of the anodic redox mediator advantageously avoids/reverses the generation of “dead metal” in the redox flow battery. Thus, in some embodiments of the invention that may be mentioned herein, a capacity fading rate of the redox flow battery may be less than 0.02%/day over at least 1500 hours.

In particular embodiments of the invention that may be mentioned herein, the redox flow battery may be an alkaline redox flow battery comprising the following features:
the anodic redox mediator comprises DHPS (e.g. 20 mM DHPS);
the catholyte optionally comprises one or both of [Fe(CN)₆]³⁻ and [Fe(CN₆)]⁴⁻ (e.g. 0.6 M [Fe(CN)₆]³⁻ and 0.05 M [Fe(CN₆)]⁴⁻);
the first metal comprises Zn;
the catholyte and anolyte each comprise an inorganic base (e.g. NaOH) (e.g. 3.8 M NaOH); and
the catholyte comprises an oxide or hydroxide of zinc (e.g. 0.3 M ZnO).

In particular embodiments of the invention that may be mentioned herein, the redox flow battery may be an alkaline redox flow battery comprising the following features:
the anodic redox mediator comprises DHPS (e.g. 20 mM DHPS);
the catholyte comprises one or both of [Fe(CN)₆]³⁻ and [Fe(CN₆)]⁴⁻ (e.g. 0.6 M [Fe(CN)₆]³⁻ and 0.05 M [Fe(CN₆)]⁴⁻);
the first metal comprises Zn;
the catholyte and anolyte each comprise an inorganic base (e.g. NaOH) (e.g. the catholyte and anolyte each comprise 3.8 M NaOH or the anolyte comprises 3.8 M NaOH and the catholyte comprises 1.8 M NaOH); and
the catholyte optionally comprises an oxide or hydroxide of zinc (e.g. 0.3 M ZnO).

In particular embodiments of the invention that may be mentioned herein, the redox flow battery may be a neutral redox flow battery comprising the following features:
the anodic redox mediator comprises a sulfonated ferrocene (e.g. 5 mM ferrocene sulfonate, sodium salt);
the catholyte optionally comprises one or both of I⁻ and I₂Br⁻
the first metal comprises Zn;
the catholyte and anolyte each comprise a neutral metal salt (e.g. NaCl, such as 1 M NaCl); and
the catholyte comprises an neutral zinc salt (e.g. ZnCl₂, such as 0.1 M ZnCl₂).

In particular embodiments of the invention that may be mentioned herein, the redox flow battery may be a neutral redox flow battery comprising the following features:
the anodic redox mediator comprises a sulfonated ferrocene (e.g. 20 mM ferrocene sulfonate, sodium salt);
the catholyte optionally comprises one or both of I⁻ and I₂Br⁻;
the first metal comprises Zn;
the catholyte and anolyte each comprise a neutral metal salt (e.g. a total of 4 M of NaCl, KBr and/or KCl); and
the catholyte comprises a neutral zinc salt (e.g. a total of 1 M of ZnCl₂, ZnBr₂, or ZnI₂).

In any of the particular embodiments discussed above, the catholyte and anolyte may be aqueous.

The invention also provides an electrolyte suitable for use in a redox flow battery comprising:
a solvent (e.g. water);
a neutral or basic metal salt; and
a redox mediator selected from one or more of the group consisting of DHPS, and a sulfonated ferrocene.

In the electrolyte according to the invention, the neutral or basic metal salt may be as described hereinabove. For example, the metal salt may comprise an oxide or hydroxide of zinc. The redox mediator may be DHPS.

The electrolyte according to the invention may further comprise an inorganic base, such as a metal hydroxide. A suitable example of a metal hydroxide is an alkali metal hydroxide (e.g. NaOH, KOH or LiOH).

The invention also provides a kit comprising an anolyte and a catholyte as described herein. For example, the invention provides a kit comprising:
(i) a catholyte comprising:
   an oxide or hydroxide of a first metal, and
   a neutral or basic metal salt; and
(ii) an anolyte comprising:
   a redox mediator having a redox potential versus a standard hydrogen electrode that is more positive than a redox potential of the first metal versus a standard hydrogen electrode, and
   the neutral or basic metal salt.

In the kit according to the invention, the first metal, neutral or basic metal salt, and redox mediator may be as described hereinabove.

For example, in some embodiments of the kit according to the invention:
the first metal may be zinc;
the neutral or basic metal salt may be selected from NaCl and NaOH;
the redox mediator may be selected from one or more of the group consisting of DHPS, and a sulfonated ferrocene,
provided that when the metal salt is NaCl, the redox mediator is a sulfonated ferrocene, and when the metal salt is NaOH, the redox mediator is DHPS.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

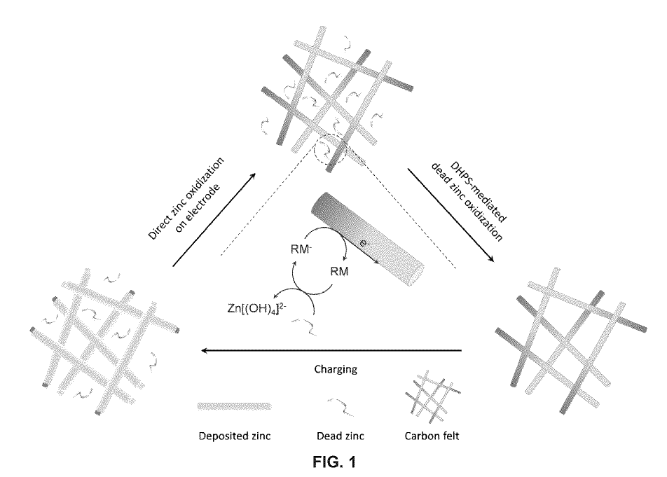

The ability of the redox flow battery of the invention to avoid the “dead metal” issue is described in relation to a zinc redox flow battery. By way of example, redox-mediated zinc chemistry may be used to solve the “dead zinc” problem in alkaline systems. As shown in FIG. 1, upon the depletion of “active zinc” (on electrode) during a discharge process, the redox mediator (RM) that is dissolved in electrolyte and has a higher potential than zinc would further oxidize the “dead zinc” chemically. The reduced RM-then shuttles back to the electrode where it is regenerated electrochemically. Subsequently, electrons are transferred from the “dead zinc” to oxidized RMs, forming Zn[(OH)₄]²⁻ in alkaline conditions and Zn²⁺ in neutral conditions. During the cycling process, the lost capacity of “dead zinc” can be continuously recovered by the redox-mediated zinc oxidation process, achieving a high stability of the cells. With such a redox-mediated closed-loop chemical-electrochemical cycle, the “dead zinc”, which is electrically segregated from the electrode, would indirectly while constantly be revitalized. As such, the inactive zinc would be instantly eliminated without accumulation during each discharge process, and the detrimental effect would be mitigated. This cycle is demonstrated experimentally in the below Examples using the redox mediators DHPS/DHPS-2H (alkaline) or Fc-SO₃Na/Fc⁺—SO₃Na (neutral). This demonstrates that the invention may be applied to both alkaline and neutral battery systems.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

Hereinafter, embodiments of the invention are illustrated in more detail with reference to the following examples. However, the present disclosure is not limited thereto. Furthermore, what is not described in this disclosure may be sufficiently understood by those who have knowledge in this field and will not be illustrated herein.

### EXAMPLES

### Materials

All chemicals were purchased from Sigma-Aldrich and used without further purification. DHPS was synthesized using the same method as the literature (Zhang, F. et al., J. Am. Chem. Soc. 2021, 143, 223-231). Nafion 115 (Dupont) membrane was purchased from Chemours. The carbon felt was purchased from Liaoyang Jingu Carbide Co., Ltd or SGL Carbon, and used as received.

### Example 1. Zinc-Based Flow Cell Assembly and Test

In the zinc-based symmetric flow cell, zinc metals pressed onto carbon felt were used as both cathode and anode.

In the alkaline zinc-iron flow cell, carbon felt was used as cathode; a piece of zinc metal pressed onto carbon felt was employed as anode. Nafion 115 membrane was used to separate the catholyte and anolyte. Viton gasket and PTFE tubing (Cole-Parmer) were employed to build the cell. The active area was 13.5 cm², and the membranes were soaked in 3.8 M NaOH overnight prior to use. For zinc-based symmetric flow cell with low areal capacity (12.2 mAh/cm²), 20 mL and 60 mL 3.8 M NaOH with/without 20 mM DHPS and 0.3 M ZnO/3.8 M NaOH were used as anolyte and catholyte, respectively. 1.65 g zinc was used for cathode and 0.20 g for anode. The current density was 20 mA/cm². For zinc-based symmetric flow cell with high areal capacity (92.0 mAh/cm²), 60 mL and 120 mL 3.8 M NaOH with 20 mM DHPS and 0.3 M ZnO/3.8 M NaOH were used as anolyte and catholyte, respectively. 4.15 g zinc was used for cathode and 1.50 g for anode. The current density was 50 mA/cm². For zinc-iron flow battery with areal capacity of 152 mAh/cm², 110 mL and 300 mL 3.8 M NaOH with 30 mM DHPS and 0.6 M Fe(CN)₆³⁻/0.05 M Fe(CN)₆⁴⁻/1.8 M NaOH were used as anolyte and catholyte, respectively. 2.50 g zinc was used for anode, and the current density was 50 mA/cm². For zinc-iron flow battery with areal capacity of 250 mAh/cm², 150 mL and 400 mL 3.8 M NaOH with 30 mM DHPS and 0.6 M Fe(CN)₆³⁻/0.05 M Fe(CN)₆⁴⁻/1.8 M NaOH were used as anolyte and catholyte, respectively. 4.06 g zinc was used for anode was, and the current density was 80 mA/cm². For the galvanostatic measurements, the batteries were charged to their theoretical capacity and discharged to a cut-off voltage. The tests were performed with an Arbin battery tester.

In the neutral zinc-iodine flow cell, carbon felt was used as cathode; a piece of zinc metal pressed onto carbon felt was employed as anode. Nafion 115 membrane was used to separate the catholyte and anolyte. Viton gasket and PTFE tubing (Cole-Parmer) were employed to build the cell. The active area was 13.5 cm², and the membranes were soaked in 1 M ZnCl₂ or 2 M KCl solutions overnight prior to use. For zinc-based symmetric flow cell, 20 mL 20 mM Fc-SO₃Na/1 M ZnCl₂ was used as anolyte and 80 mL 1 M ZnCl₂ was used as catholyte. 0.2 g zinc was used for anode and 1.5 g zinc was used for cathode. The current density was 20 mA/cm². For zinc-iodine flow cell, 30 mL 1 M ZnI₂+2 M KBr+2 M KCl was used as the catholyte and 20 mL 1 M ZnI₂+2 M KBr+2 M KCl+20 mM Fc-SO₃Na was used as the anolyte, the current density was 20 mA/cm².

### Example 2. Electrochemical Measurements

Cyclic voltammetric (CV) measurements were carried out with an Autolab electrochemical workstation (Metrohm, PGSTAT30) using a three-electrode configuration composed of a glassy carbon working electrode, a platinum plate counter electrode and an Hg/HgO reference electrode. The glassy carbon working electrode was polished with 0.3 and 0.05 μm of alumina slurry for 2 minutes and then sonicated in deionized water before every test. To determine the overpotentials of different cell components, 4-electrode electrochemical characterization was performed, for which 60 mL of 0.6 M Fe(CN)₆³⁻/0.05 M Fe(CN)₆⁴⁻/1.8 M NaOH and 20 mL 3.8 M NaOH with/without 7 mM DHPS+0.1 g zinc plate on carbon felt or 30 mL 3.8 M NaOH with 20 mM DHPS were used as catholyte and the anolyte, respectively. Two Hg/HgO reference electrodes were inserted in both the positive and negative electrode compartments, the active area was 5 cm² and the current density was 30 mA/cm².

### Example 3. Characterisation

In situ UV-Vis spectra of the DHPS-mediated zinc oxidization reactions were collected with a SHIMADZU UV-1800 spectrometer. The setup includes a reaction tank, a DHPS electrolyte, a pump, a piping system, a detector, a monochromator, and a light source. A custom-designed spectroelectrochemical cell with 0.6 mm optical path length was connected to the outlet of the reaction tank. The absorbance changes of DHPS were recorded during the reaction process. For the chemical reaction test, the supporting electrolyte was 3.8 M NaOH and for the kinetics test, the supporting electrolyte was 0.4 M Zn(OH)₄²⁻/3 M NaOH.

Operando FTIR measurement was carried out with a PerkinElmer Frontier MIR/FIR system by the attenuated total reflection (ATR) mode to detect the structural evolution of DHPS during different stages. The setup includes a catholyte, an anolyte including zinc, pumps, flow fields, electrodes, a membrane, an IR source, and a detector. The DHPS flowed through the ATR crystal and the FTIR spectra were collected from 1600 to 1000 cm⁻¹ with a resolution of 4 cm⁻¹.

XRD measurements were conducted on a Powder XRD Diffractometer System (Bruker D8 Advance) and SEM measurements were conducted on Zeiss Supra 40.

### Example 4. DHPS-Mediated Zinc Chemistry

The half-wave potentials (E_{1/2}) of DHPS and Zn were measured by CV. the E_{1/2} of DHPS/DHPS-2H and [Zn(OH)₄]²⁻/Zn couples are −0.90 V and −1.30 V (vs. standard hydrogen electrode (SHE)), respectively. Thus, the driving force of DHPS-mediated zinc oxidization reaction can be as large as 0.40 V. The reaction between DHPS and zinc was first monitored by in-situ UV-Vis spectroscopy through a spectroelectrochemical flow cell. The UV-Vis spectrum of DHPS solution showed major absorption at around 435 nm which became attenuated after adding excess zinc. Meanwhile, another absorption peak at 354 nm arising from the formation of DHPS-2H emerged and became stronger with reaction. The concentration changes of DHPS and DHPS-2H are calculated based on the standard calibration curve. After adding zinc in DHPS solution, the absorbance of DHPS-2H at 470 nm shot up nearly instantaneously and reached steady state in a short time, suggesting a swift reaction which will be further discussed later. The concentration of DHPS-2H was stabilized at 1.1 mM while that of DHPS was reduced from 1.4 to 0.3 mM, indicating the chemical reaction between zinc and DHPS can be triggered even with small amount of DHPS in electrolyte.

To elucidate the mechanism of DHPS-mediated zinc oxidization reaction, ATR-FTIR spectroscopy was conducted at different stages of the reaction, with which the bonding information of DHPS could be detected in real-time. The stretching vibration of C═N at 1550 cm⁻¹ which was clearly observed during the resting process gradually vanished after adding zinc into the electrolyte (Sun, T. et al., Nano Res. 2020, 13, 676-683). In the meantime, a new peak at 1272 cm⁻¹ assigned to the formation of C—N bond appeared, indicative of the reduction of DHPS (Li, L. et al., J. Mater. Chem. A 2020, 8, 26013-26022). Interestingly, during the subsequent discharge process, no C═N vibration reappeared while the C—N group of reduced DHPS remained, indicating the DHPS-mediated zinc oxidization process reached a steady state. The two-step closed-loop DHPS-mediated zinc oxidization chemistry is described below. During discharge process, DHPS-2H is electrochemically oxidized by losing electrons to the electrode:

DHPS-2H+2OH⁻−-2e⁻→DHPS+2H₂O (1)

The oxidized DHPS is then reduced by zinc in the vicinity as observed by UV-Vis measurement:

DHPS+2OH⁻+Zn+2H₂O→DHPS-2H+Zn(OH)₄²⁻ (2)

As the flux of DHPS formed on electrode balances that consumed by zinc oxidization off electrode, the system reaches steady state as indicated by ATR-FTIR measurement.

### Example 5. Kinetics Study

The reaction rate between DHPS and zinc is dictated by different parameters, such as the concentration of [Zn(OH)₄]²⁻ in electrolyte, mass transport of DHPS and energy barrier for interfacial charge transfer, and etc. So, the kinetics study was first conducted by monitoring the OCP changes of DHPS in the presence of excess zinc powder (Zhang, H. et al., Adv. Mater. 2021, 33, 2006234). The whole reaction process was protected with N₂ gas with a rotating disk electrode (RDE) as the working electrode (WE) and Hg/HgO electrode as the reference electrode (RE). The OCP changes with time and the slope b may be calculated:

$$b = \frac{dE}{d t} \qquad ( 3 )$$

where E is the equilibrium potential of the DHPS, which is determined by Nernst equation:

$$E = {E}_{DHPS}^{0} + \frac{R T}{2 F} ln \frac{{C}_{DHPS}}{{C}_{DHPS - 2 H}} \qquad ( 4 )$$

Here, E_{DHPS}⁰ is the formal potential and the slope can thus be written as:

$$b = \frac{R T}{2 F} \cdot \frac{{C}_{DHPS}^{0}}{{C}_{DHPS} {C}_{DHPS - 2 H}} \cdot \frac{d {C}_{DHPS}}{dt} \qquad ( 5 )$$

Here, C_{DHPS}⁰ is the initial concentration of DHPS. Considering the evolution of OCP is solely dictated by the chemical reactions, a normalized effective current is defined to describe the flux of the reaction (Zhou, M. et al., Chem 2017, 3, 1036-1049; and Zhou, M. et al., Adv. Energy Mater. 2019, 9, 1901188):

$${i}_{eff}^{n} = FV \cdot \frac{{dC}_{DHPS}}{dt} \cdot \frac{{C}^{0}}{{C}_{DHPS}} \qquad ( 6 )$$

Further, we can get the relation between i_{eff}ⁿ and b:

$${i}_{eff}^{n} = b \cdot \frac{2 {F}^{2} {VC}^{0}}{R T} \cdot \frac{{C}_{DHPS - 2 H}}{{C}_{DHPS}^{0}} \qquad ( 7 )$$

Here, R is the universal gas constant, T is the absolute temperature (298 K), F is the Faraday constant, V is electrolyte volume, 0 is 1 M. For the condition of the same overpotential

$$( η = E - {E}_{{Zn ( OH )}_{4}^{2 -} / Zn}^{0} ) , where \frac{{C}_{DHPS - 2 H}}{{C}_{DHPS}^{0}}$$

is constant, it leads to a linear relation between b and i_{eff}ⁿ. Thus, a larger slope (b) would correspond to a faster reaction rate. With increasing concentration of [Zn(OH)₄]²⁻ or decreasing concentration of DHPS, the slope of OCP vs. time decreases, indicating an attenuated reaction rate between DHPS and zinc.

Considering the presence of soluble [Zn(OH)₄]²⁻ in the electrolyte may affect the OCP measurement of DHPS/DHPS-2H, the concentration of DHPS was determined by in-situ UV-Vis spectroscopy. Since there is a large potential difference between DHPS/DHPS-2H and [Zn(OH)₄]²⁻/Zn, a Tafel behavior between i_{eff}ⁿ and η is expected, which allows the determination of the exchange current i₀:

$$η = \frac{RT}{α F} {lni}_{0} - \frac{RT}{α F} {lni}_{eff}^{n} \qquad ( 8 )$$

Here, α is the transfer coefficient. The flux of reaction increases with overpotential. As η>0.32 V, i_{eff}ⁿ becomes saturated, suggesting a mass transport-limited process. At lower overpotentials, the interfacial charge transfer process would become the rate-determining step and present a linear change of log (i_{eff}ⁿ) vs. η, while a clear deviation was observed (see the dashed line by setting α as 1 for a one-way charge transfer process). Considering that at low η, the concentration of DHPS drops to a relatively low level, such a deviation could be rationalized by the presence of trace oxygen which rapidly oxidizes DHPS-2H and attenuates the drop of DHPS concentration, and thus the effective reaction flux i_{eff}ⁿ·i₀ is estimated to be around 2.7×10⁻⁵ A by extrapolating the dashed line to an intercept of log (i₀).

Note that i₀ for DHPS/DHPS-2H on the glassy carbon electrode is around 3.3×10⁻⁵ A, which is comparable to the redox-targeting reaction rate on zinc.

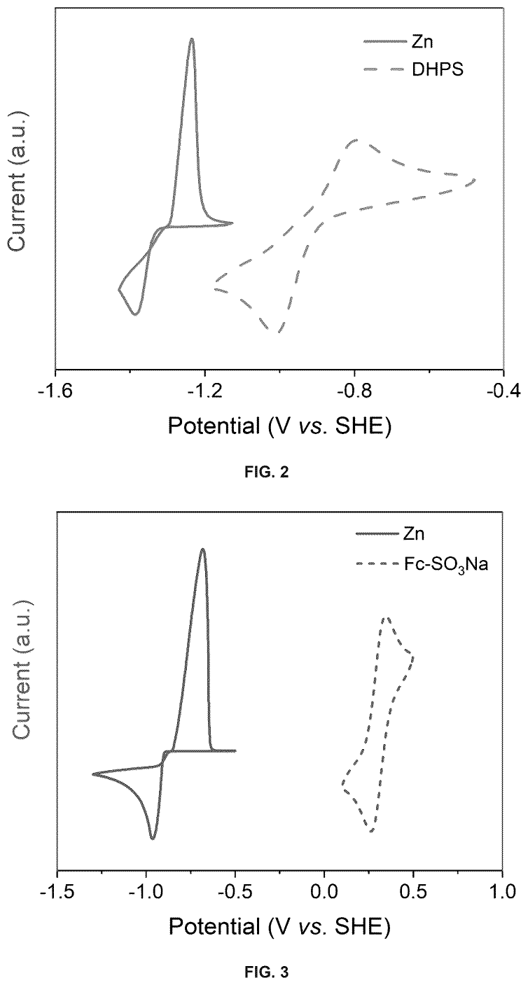

In addition to the comparable CV peak current, the peak-to-peak separation (ΔE) between the anodic and cathodic peak potentials of zinc was ˜0.17 V regardless of the presence of DHPS in the electrolyte (FIG. 2), indicating DHPS has no noticeable effect on the reaction of [Zn(OH)₄]²⁻/Zn.

The molecule with redox potential more positive than that of zinc (>−1.26 V vs. SHE in alkaline condition, and >−0.76 V vs. SHE in neutral condition) can be used for zinc oxidization process. The redox potentials of DHPS/DHPS-2H and Fc-SO₃Na/Fc⁺—SO₃Na were measured in 3.8 M NaOH and 1 M NaCl by CV method, respectively. As shown in FIG. 2, the redox potential of DHPS/DHPS-2H couple is-0.90 V (vs. SHE), which is higher than that of Zn/Zn[(OH)₄]²⁻ couple and can be employed as RM in alkaline condition. The redox potential of Fc-SO₃Na/Fc⁺—SO₃Na is 0.30 V (vs. SHE), which is more positive than that of Zn/Zn²⁺ couple, making it a possible RM for neutral condition (FIG. 3).

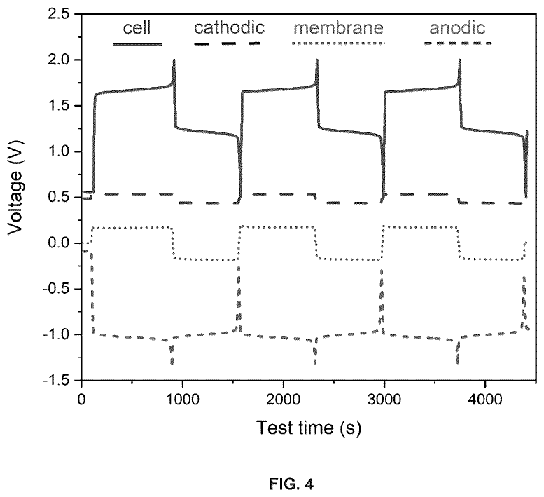

Furthermore, a four-electrode measurement with two Hg/HgO reference electrodes (RE) in both the positive and negative electrode compartments was conducted to monitor the local voltage drop across different cell components of Zn/[Fe(CN)₆]^{3-/4-} flow cells with and without DHPS in anolyte (Gao, M. et al., Mater. Today Energy 2020, 18, 100540; and Weng, G.-M. et al., Energy Environ. Sci. 2017, 10, 735-741). The voltage drops ΔV₊ between the positive electrode and RE₁, ΔV₊ between the negative electrode and RE₂, ΔVₘ between RE₁ and RE₂ across the membrane, and ΔV_{c} between the positive and negative electrodes were monitored during the charge and discharge processes at a current density of 30 mA/cm². The differences of ΔV₋ between the charge and discharge processes for the anolyte with and without DHPS are 42 and 47 mV respectively, suggesting the presence of DHPS has no adverse effect on zinc reaction kinetics. In addition, the differences of ΔV_{c}, ΔVₘ and ΔV₊ between charging and discharging of the flow cell in the presence of DHPS were further analyzed and calculated to be 793, 350 and 41 mV, respectively. Obviously, the value for the overall cell voltage ΔV_{c} is considerably greater than the sum of ΔVₘ, ΔV₊ and ΔV₊, suggesting the voltage loss also arises from the series resistance of the flow cell (˜306 mV), in addition to that of the membrane. Similar results were also obtained from the 4-electrode measurement of a DHPS/[Fe(CN)₆]^{3-/4-} flow cell in the absence of zinc. Results are shown in FIG. 4.

### Example 6. Zinc-Based Symmetric Flow Cell

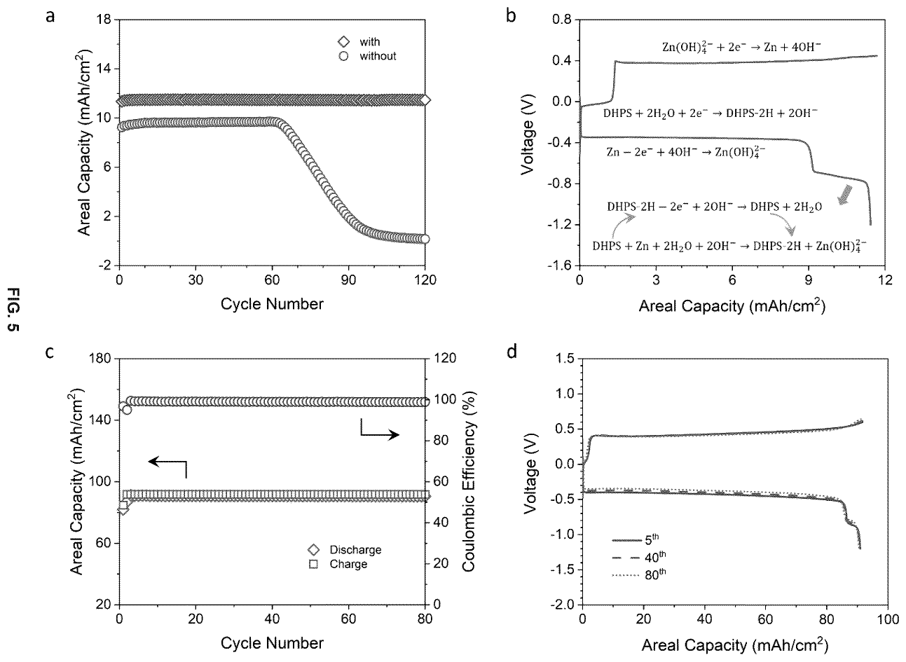

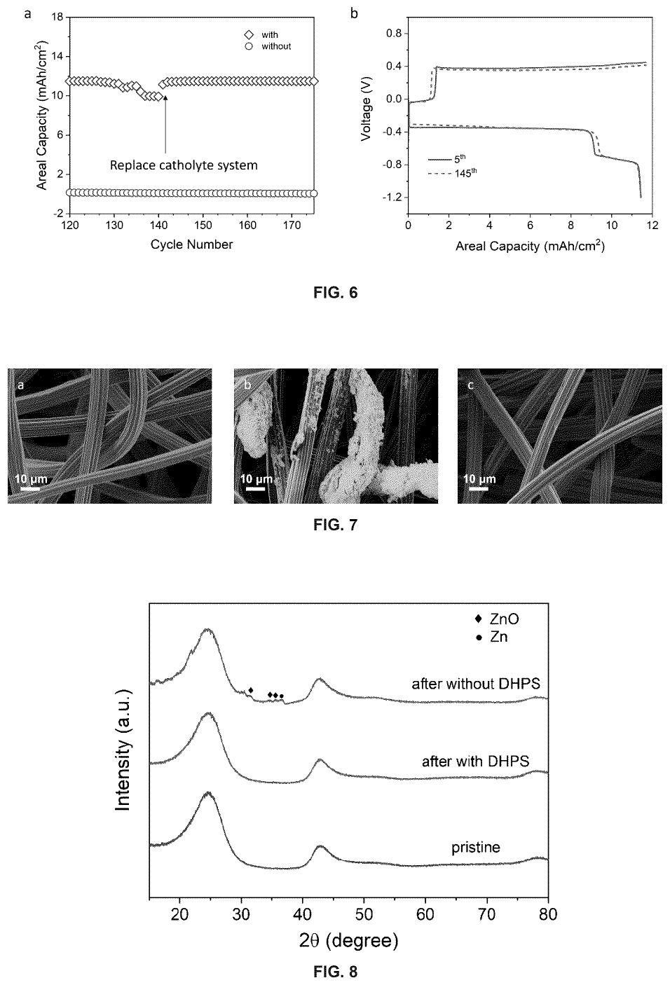

Zinc-based symmetric flow cells were assembled (as described in Example 1) to study the role and performance of DHPS. FIG. 5a shows the cycling stability of flow cells with and without DHPS in anolyte at a current density of 20 mA/cm² and 100% DOD (charged to the theoretical capacity of zinc and fully discharged to a cutoff voltage), while at a relatively low areal capacity of zinc (12.2 mAh/cm²). For the cell without DHPS in anolyte, the utilization of zinc was around 79% (9.6 mAh/cm²) in the first 62 cycles and then gradually decreased to nearly zero with a capacity fading rate of about 0.27 mAh/cm² per cycle. In stark contrast, in the presence of 20 mM DHPS in anolyte, the zinc utilization was improved to 94% (11.5 mAh/cm²), and there wasn't obvious capacity decay in the first 120 cycles. Its capacity started to drop from the 125th cycle, while it was instantaneously recovered with the replacement of counter electrode, indicating the capacity fading was originated from the depletion of active zinc on the counter electrode (FIG. 6). The representative voltage profiles of the cell are shown in FIG. 5b. During the discharge process, the long high-voltage plateau corresponds to the stripping of active zinc on the electrode, and it follows a short low-voltage plateau of the oxidization of DHPS-2H and the associated DHPS-mediated “dead zinc” oxidization. This is substantiated by the excess capacity of the second plateau than the theoretical capacity of DHPS (2.2 mAh/cm² vs. 1.6 mAh/cm²). Moreover, the surface of carbon felt electrode after cycling was as clean as the pristine one in the presence of DHPS in anolyte (see the SEM images in FIG. 7). In contrast, some spots of zinc and ZnO deposits were observed on carbon felt in the absence of DHPS (FIG. 8).

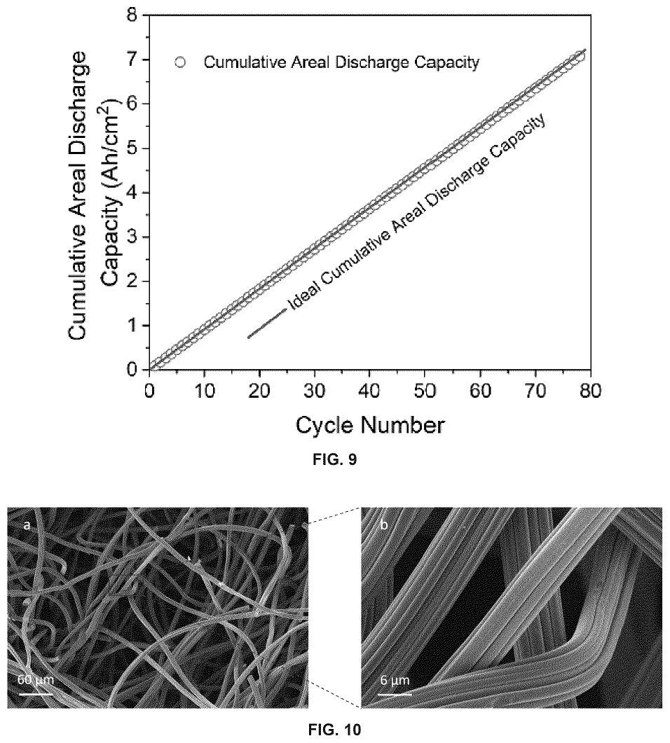

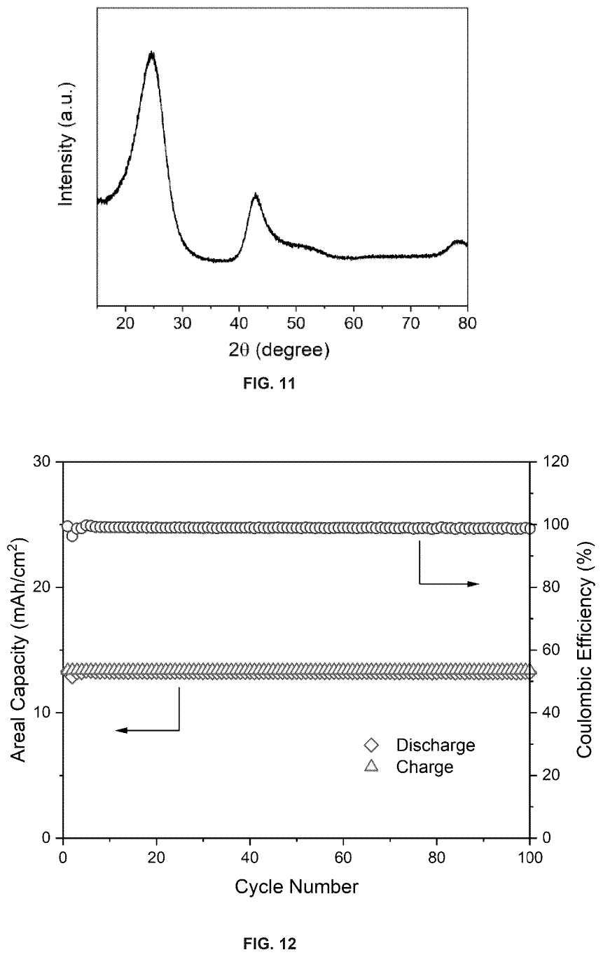

To further assess the ability of DHPS for revitalizing the “dead zinc”, a zinc-based symmetric flow cell with a higher areal capacity (92.0 mAh/cm²) of zinc and 20 mM DHPS in anolyte was tested at a current density of 50 mA/cm² and 100% DOD. As shown in FIG. 5c, the cell exhibited a discharge capacity of ˜90.8 mAh/cm² and a coulombic efficiency (CE) of 98.9%. Considering the cell was charged to the theoretical capacity of zinc and fully discharged, CE also broadly corresponds to the utilization rate of zinc in each cycle given the discharge capacity of DHPS is negligible (FIG. 5d). Cumulative discharge capacity was employed to assess the cycling stability of the DHPS-mediated zinc symmetric flow cell (FIG. 9) (Chen, Y. et al., Joule 2019, 3, 2255-2267), which was determined to be 7.08 Ah/cm² after 78 cycles (theoretically 7.11 Ah/cm²), corresponding to a remarkably low capacity fading rate of 0.005%/cycle. Importantly, there wasn't deterioration in polarization of the voltage profiles during the entire cycling process (FIG. 5d) and the morphology of carbon felt after cycling was nearly as clean as the pristine one (FIGS. 10-11). These results corroborate the ultra-stable cycling performance of the DHPS-mediated zinc oxidization process in operation conditions, showing great promise in zinc-based full cell application.

Except for the alkaline condition, the zinc based symmetric flow battery was also tested under the neutral condition with 20 mM Fc-SO₃Na as RM. As shown in FIG. 12, the zinc based symmetric flow battery can achieve a stable 100 cycles with almost no capacity fade under the current density of 20 mA/cm² and the CE can reach a high value of 98.9%.

In this disclosure, with the assistance of RM dissolved in the electrolyte, the cycling stability of zinc electrode is greatly enhanced at high DOD and areal capacity. As an example, DHPS was used as the RM for the alkaline zinc-based flow batteries, while anionic sulfonated ferrocene derivative (Fc-SO₃Na) was used as the RM for neutral zinc-based flow batteries. The formed “dead” zinc was effectively revitalized in each cycle.

The redox molecules which potentially could be used with zinc is summarized in FIG. 13.

### Example 7. Alkaline Zinc-Iron Flow Battery (AZIFB)

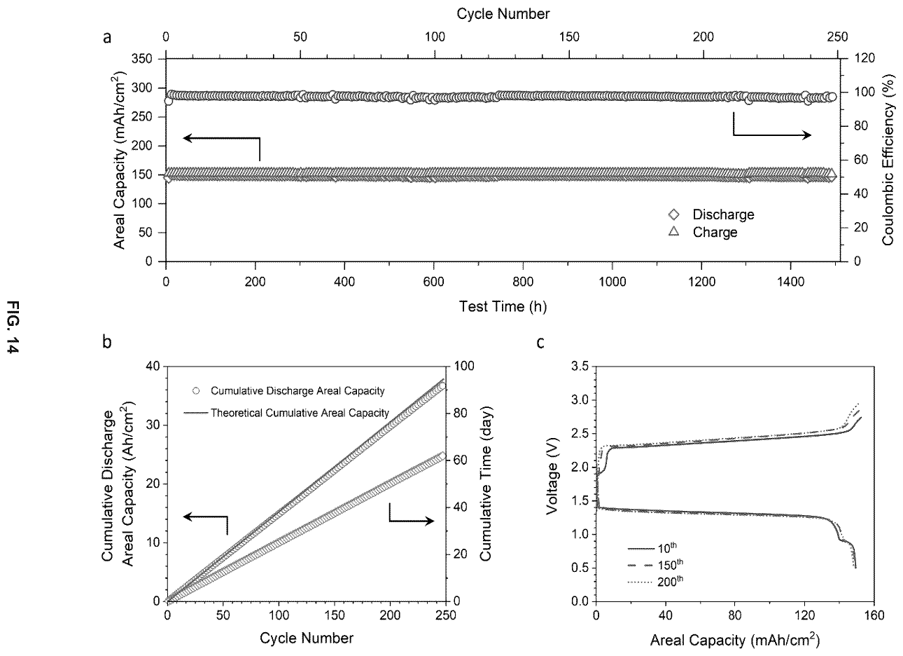

With the promising results of symmetric cells, we further investigated the DHPS-mediated “dead zinc” revitalization process in Zn/[Fe(CN)₆]^{3-/4-}-based deep-cycle flow battery full cells. The cycling performance of an AZIFB with a zinc areal capacity of 152 mAh/cm² was tested at a current density of 50 mA/cm² (FIG. 14a). The AZIFB with 30 mM DHPS in anolyte exhibited a stable cycling performance over 1500 h. The cell was charged up to the theoretical capacity (calculated by the amount of zinc used for the anode). Therefore, the zinc is almost 100% active during the whole cycling process.

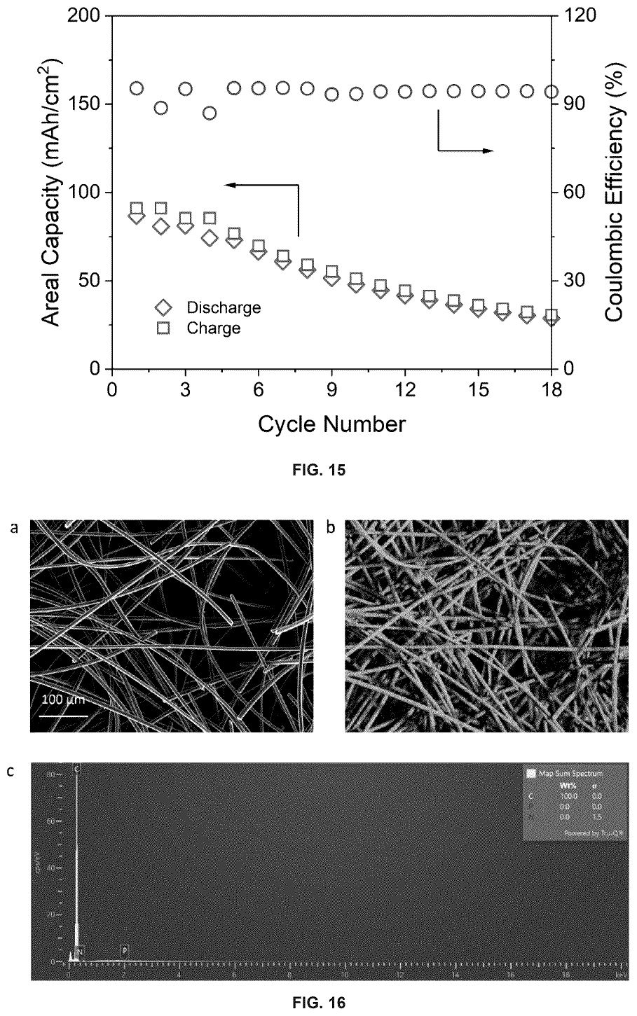

To have a more accurate assessment of the capacity fading rate, cumulative discharge capacity vs. time was plotted to analyse the durability of the AZIFB, as shown in FIG. 14b. With 30 mM DHPS in anolyte, the AZIFB exhibited ultra-stable cycling performance over 1,500 h with an average CE of 97.5%. As the cell was charged to the theoretical capacity of zinc loaded in the cell, it suggests the utilization of zinc is nearly unity during the entire cycling process. The capacity fading rate was determined based on the cumulative discharge capacity over cycle number and time (97.5%×theoretical capacity of zinc×cycle number, FIG. 14b) (Chen, Y. et al., Joule 2019, 3, 2255-2267), which was determined to be 36.7 Ah/cm² after 247 cycles (from the 2nd cycle to 248th cycle). Considering the theoretical cumulative value is 37.1 Ah/cm² (based on the discharge capacity of the 2nd cycle), the capacity fading rate was calculated to be 0.0048%/cycle or 0.019%/day, corresponding to a 93.3% capacity retention after 1 year of continuous operation. This represents the best reported cycling performance for deep-cycle zinc-based flow cells. An AZIFB without DHPS in anolyte was also tested (FIG. 15). Even at a lower areal capacity of 92.0 mAh/cm² and current density of 20 mA/cm², the battery showed a rapid capacity decay of 3.3 mAh/cm² per cycle.

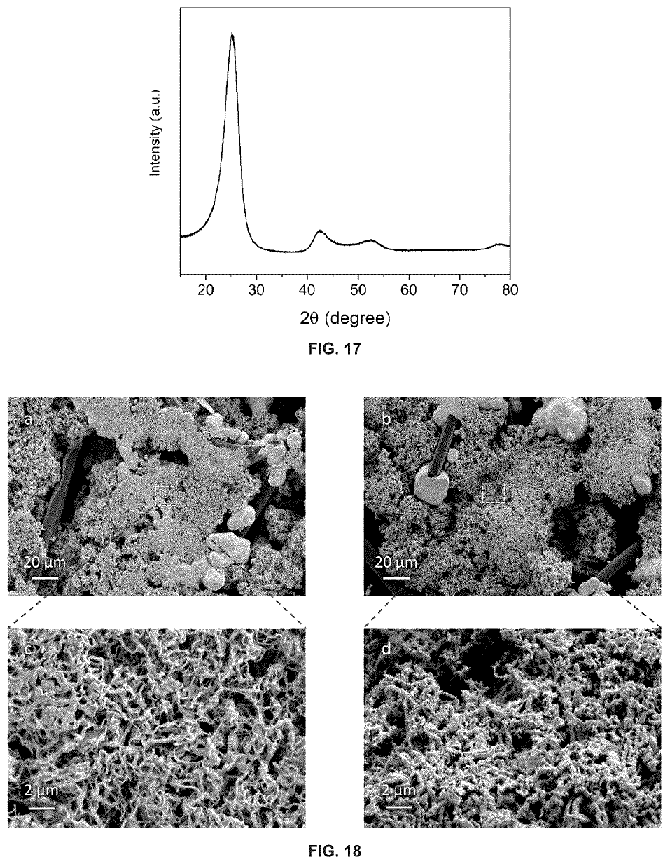

FIG. 14c shows the voltage profiles of the AZIFB in the 10th, 150th, and 200th cycle. The long plateaus of the discharge and charge curves are respectively associated with zinc oxidization and [Zn(OH)₄]²⁻ reduction process, while the short plateaus correspond to those of DHPS-2H and DHPS. As the capacity of DHPS is considerably smaller than that of Zn, the potential mismatch between DHPS and Zn only has marginal effect on the overall energy efficiency (EE). As revealed by the previous 4-electrode measurement and kinetic studies, the relatively low EE of the AZIFB is mainly attributed to the large series resistance of the cell, and it is anticipated there is ample room to improve by optimizing the cell design and membrane compared with the reported ones (Hu, J. et al., Adv. Funct. Mater. 2021, 31, 2102167; Hu, J. et al., Angew. Chem. Int. Ed. 2020, 59, 6715-6719; and Wu, J. et al., J. Am. Chem. Soc. 2021, 143, 13135-13144). Moreover, the discharge capacity of DHPS-2H was higher than the charge capacity of DHPS by around 4.40 mAh/cm² in the 10th cycle, indicating a similar amount of “dead zinc” was restored by DHPS. This value became slightly higher in the 150th, and 200th cycle, suggesting the formation of more inactive zinc with cycling, despite the effective revitalization by DHPS in each cycle. In addition, seemingly, there is a loss of DHPS capacity with cycling while the overall discharge capacity remains nearly unchanged (note the shortened low voltage charging plateau in the 150th, and 200th cycle is partly due to smaller sampling points to reduce the file size during long time measurement). Moreover, the carbon felt remained intact after such a long cycling process (FIGS. 16-17). These results collectively attest the efficacy of DHPS-mediated zinc chemistry in battery cycling performance.

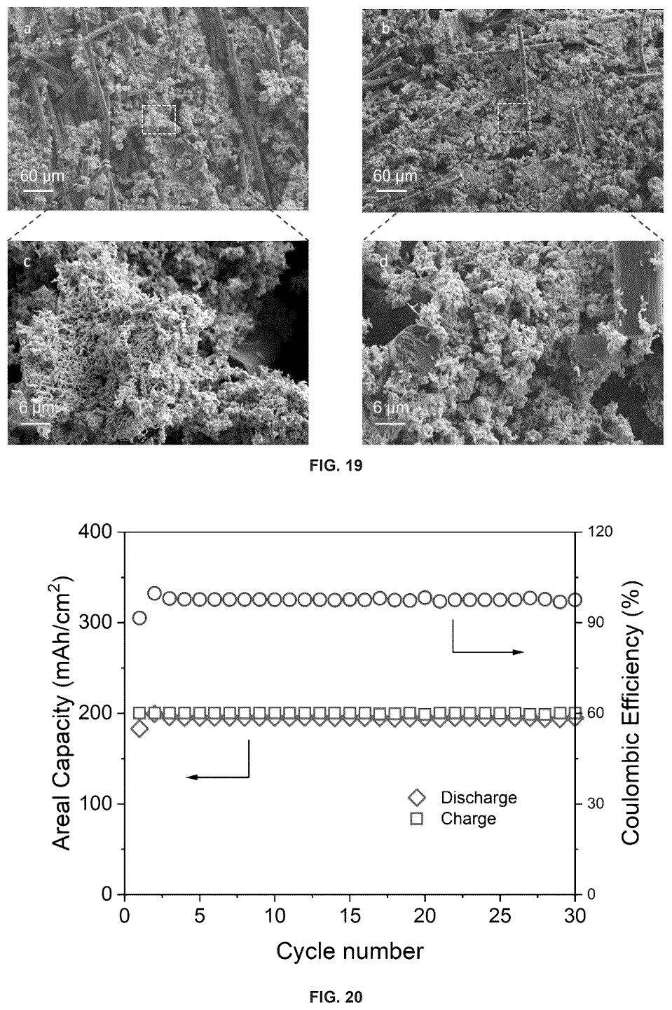

To gain further insight into the effect of DHPS on Zn deposition during the charge process, we characterized the morphology of deposited Zn (152 mAh/cm² at 50 mA/cm²) on the anodic carbon felt. From the SEM images, it seems the presence of DHPS has no obvious influence on Zn deposition, which shares similar morphology to those reported in literature (Wang, R. Y., Kirk, D. W. & Zhang, G. X., J. Electrochem. Soc. 2006, 153, C357). The top view of the caron felt electrode in FIG. 18 shows the deposited Zn varies from micrometer sized “boulder-like” particles with clear crystal facets surrounding single carbon fibers to sub-micrometer “moss-like” porous deposit filled in between the fibers. In comparison, porous Zn deposit predominates inside the carbon felt from the cross-sectional view in FIG. 19.

In addition to the cycling stability of Zn electrode, the areal capacity is another crucial design parameter for AZIFBs. For a given total electrode area (or power), a higher areal capacity of Zn leads to a higher energy, particularly useful for long-duration discharge applications.

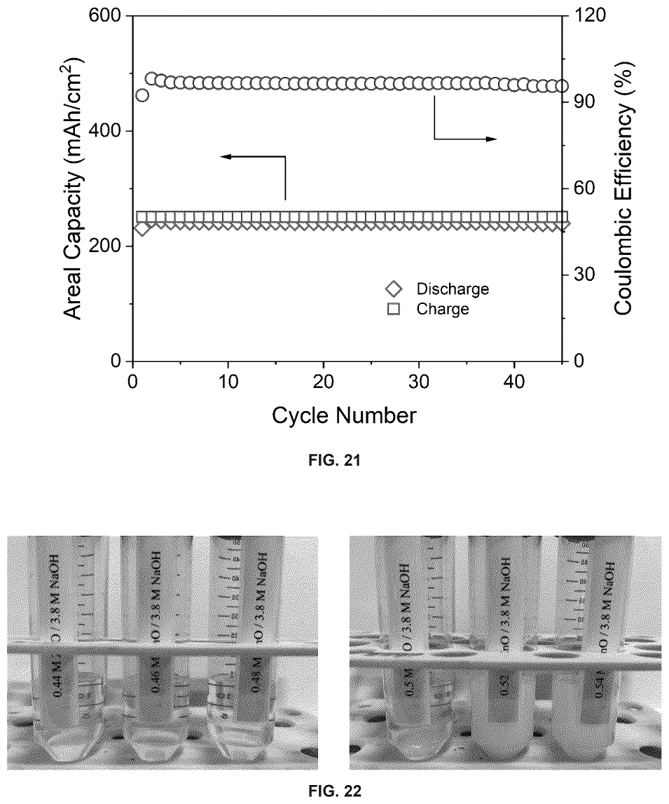

Similarly, for a given energy requirement, a higher areal capacity of Zn would only necessitate a smaller electrode area (or number of single cells in a stack) if the power requirement is met, which reduces the cost (see Example 8 below). To evaluate the DHPS-mediated Zn chemistry at high areal capacity, AZIFBs with 200 and 250 mAh/cm² of Zn loading were tested at 80 mA/cm² and 100% DOD (FIGS. 20-21). Good cycling stability with an average CE of 97.4% and 96.4% was achieved at such a high current density and DOD, respectively, revealing the excellent robustness of DHPS-mediated Zn oxidization reaction for practical applications. While the above cycling stability tests for Zn are rigorous, for alkaline Zn-based flow batteries, the limited solubility of [Zn(OH)₄]²⁻ (or ZnO) at high pH, which commonly entails a low volumetric capacity of the anolyte, should be addressed for high density energy storage. As shown in FIG. 22, the solubility of ZnO in 3.8 M NaOH is around 0.5 M, which is translated into a volumetric capacity of only 26.8 Ah/L.

In this study, DHPS was used as the RM for its suitable redox potential, high chemical stability as well as fast reaction rate in alkaline conditions. With the DHPS-mediated strategy, an AZIFB using Zn as anode and ferricyanide as catholyte active species, has demonstrated drastically enhanced cycling stability at high areal capacity of Zn up to 250 mAh/cm² at near unity zinc utilization. In particular, a cell with 152 mAh/cm² of Zn areal capacity could operate at 100% DOD and a current density of 50 mA/cm² for more than 1,500 hours with a capacity fading rate of 0.019%/day, which is the best ever reported. We anticipate that such a redox-mediated strategy would have broad applicability in other electrolyte systems involving solid/liquid phase transformation reactions, and provides a credible way to ultimately address the “dead zinc” issue for ultra-robust and deep-cycle zinc-based redox flow batteries.

### Example 8. Analysis of AZIFB with Different Zinc Areal Capacity

Condition one: For a fixed power (P) requirement with a single electrode active area (A) of 0.89 m², current density (j) of 50 mA/cm² and single cell voltage (U0) of 1.5 V.

Here, we take 10 KW as an example:

$$P = U \times I = n \times {U}_{0} \times j \times A = n \times 1.5 \times 0 \text{.05} \times 8900 = 10000$$

The number of single cell (n) is calculated to be 15.

The energy (E) can be calculated based on:

$$E = Q \times U = n \times {Q}_{Areal} \times A \times n \times {U}_{0} = {15}^{2} \times 1.5 \times 8900 = \times {Q}_{Areal}$$

Here, the Q_{Areal} is the areal capacity of a single cell.

For the battery with a low Q_{Areal} of 20 mAh/cm², E is calculated to be around 60 kWh, which can continuously work for 6 h.

For the battery with a high Q_{Areal} of 200 mAh/cm², E is calculated to be around 600 kWh, which can continuously work for around 60 h.

As a result, high areal capacity is benefit for the long duration operation condition when satisfies the power requirement.

Condition two: For a fixed energy requirement and that the basic power requirement is satisfied, where the single electrode active area (A) is 0.89 m², the current density (j) is 50 mA/cm² and voltage of single cell (U₀) is 1.5 V.

Here, we take 600 kWh as an example:

The energy (E) can be calculated based on:

$$E = Q \times U = n \times {Q}_{Areal} \times A \times n \times {U}_{0} = {n}^{2} \times 1.5 \times 8900 \times {Q}_{Areal} 600000$$

For the battery with a high Q_{Areal} of 200 mAh/cm², the number of single cell (n) is calculated to be around 15.

For the battery with a low Q_{Areal} of 20 mAh/cm², the n is calculated to be around 47.

As a result, in order to achieve the same energy, the number of single cells will increase from 15 to 47 when the areal capacity is reduced from 200 to 20 mAh/cm². Therefore, at such a condition, larger areal capacity can reduce the number of single cells in stack and thus the cost (Moore, M. A et al., In A Comparison of the Capital Costs of a Vanadium Redox-Flow Battery and a Regenerative Hydrogen-Vanadium Fuel Cell, 2015).

Taken together, a DHPS-mediated zinc chemistry was studied for the first time in alkaline Zn-based flow cells to revitalize the capacity of “dead zinc”. The presence of low concentration DHPS in anolyte, resorting to the fast redox-targeting reaction with the inactive zinc, leads to remarkably enhanced cycling performance of zinc electrode at high areal capacity and deep-cycle conditions. Based on this strategy, an ultra-stable AZIFB with a high zinc loading of 152 mAh/cm² was demonstrated at 50 mA/cm² and 100% DOD, which presented an ultralow capacity fading rate of 0.019%/day for more than 1,500 hours. Furthermore, the AZIFB achieved a high zinc utilization of 96.5% at an even higher areal capacity of 250 mAh/cm² and a current density of 80 mA/cm² during prolonged cycling. With the rigorous tests, the approach demonstrated in this work provides a credible solution to the long-lifetime and deep-cycle application of alkaline Zn-based flow cells at high material loading and current density. In addition, the redox-mediated approach is expected to provide an effective way to universally address the capacity loss issue of other metal-based batteries with different electrolyte conditions.

As demonstrated above, the invention provides an effective solution to the “dead metal” problem, as exemplified in the context of “dead zinc” in zinc redox flow batteries.

1. A redox flow battery, comprising:
a catholyte compartment, comprising a catholyte, and a cathode;
an anolyte compartment, comprising an anolyte, and an anode comprising a first metal; and
an ion selective membrane disposed between the cathode compartment and anode compartment,
wherein:
the first metal is selected from the group consisting of an alkali metal, an alkaline earth metal, a Group III metal, and a transition metal;
the anolyte comprises an anodic redox mediator; and
the anodic redox mediator has a redox potential versus a standard hydrogen electrode that is more positive than a redox potential of the first metal versus a standard hydrogen electrode.

2. The redox flow battery according to claim 1, wherein the anodic redox mediator is selected from one or more of the group consisting of a phenazine redox mediator, a quinone redox mediator, a viologen redox mediator, a ferrocene derivative, an nitroxide radical redox mediator, and an alloxazine redox mediator.

3. The redox flow battery according to claim 1, wherein the catholyte further comprises a cathodic redox mediator.

4. The redox flow battery according to claim 3, wherein the cathodic redox mediator comprises one or more of the following pairs:
[Fe(CN)₆]³⁻/[Fe(CN₆)]⁴⁻;
O₂/OH;
MnO₄⁻/MnO₄²⁻;
I₃⁻/I⁻;
Br₂/Br⁻;
(I⁻, Br⁻/I₃⁻, I₂Br⁻);
Fe³⁺/Fe²⁺;
(2,2,6,6-Tetramethylpiperidin-1-yl)oxyl (TEMPO) derivatives; and
MnO₂/Mn²⁺.

5. The redox flow battery according to claim 3, wherein the concentration of the cathodic redox mediator in the catholyte is at least 0.3 M.

6. The redox flow battery according to claim 1, wherein the catholyte comprises a salt of the first metal.

7. The redox flow battery according to claim 1, wherein the concentration of the anodic redox mediator in the anolyte is from 0.001 M to 1 M.

8. The redox flow battery according to claim 1, wherein:
(a) the catholyte and anolyte each comprise an inorganic base; or
(b) the catholyte and anolyte each comprise a neutral metal salt.

9. The redox flow battery according to claim 8, wherein:
(a) the catholyte and anolyte each comprise an inorganic base, and the anodic redox mediator is DHPS; or
(b) the catholyte and anolyte each comprise a neutral metal salt, and the anodic redox mediator is a sulfonated ferrocene.

10. (canceled)

11. The redox flow battery according to claim 1, wherein the first metal is selected from the group consisting of an alkali metal, an alkaline earth metal, aluminium, zinc, and iron.

12. The redox flow battery according to claim 1, wherein the first metal is Zn.

13. (canceled)

14. The redox flow battery according to claim 1, wherein the anode comprises carbon and the first metal.

15. The redox flow battery according to claim 1, wherein one or both of the following apply:
(a) a current density of the redox flow battery is from 10 mA/cm² to 300 mA/cm²; and
(b) a discharge capacity of the redox flow battery is from 10 mAh/cm² to 450 mAh/cm².

16. (canceled)

17. The redox flow battery according to claim 1, wherein a capacity fading rate of the redox flow battery is less than 0.02%/day over at least 1500 hours.

18. The redox flow battery according to claim 1, wherein the catholyte and anolyte are aqueous.

19. The redox flow battery according to claim 1, wherein:
the anodic redox mediator comprises DHPS;
the catholyte comprises one or both of [Fe(CN)₆]³⁻ and [Fe(CN₆)]⁴⁻;
the first metal comprises Zn;
the catholyte and anolyte each comprise an inorganic base (e.g. NaOH); and
the catholyte comprises an oxide or hydroxide of zinc.

20. The redox flow battery according to claim 1, wherein:
the anodic redox mediator comprises a sulfonated ferrocene;
the catholyte comprises one or both of I⁻ and I₂Br⁻,
the first metal comprises Zn;
the catholyte and anolyte each comprise a neutral metal salt; and
the catholyte comprises an neutral zinc salt.

21. (canceled)

22. An electrolyte suitable for use in a redox flow battery comprising:
a solvent;
a neutral or basic metal salt; and
a redox mediator selected from one or more of the group consisting of DHPS, and a sulfonated ferrocene.

23. The electrolyte according to claim 22, wherein:
the metal salt comprises an oxide or hydroxide of zinc; and
the redox mediator is DHPS.

24. (canceled)

25. A kit comprising:
(i) a catholyte comprising:
an oxide or hydroxide of a first metal, and
a neutral or basic metal salt; and
(ii) an anolyte comprising:
a redox mediator having a redox potential versus a standard hydrogen electrode that is more positive than a redox potential of the first metal versus a standard hydrogen electrode, and
the neutral or basic metal salt.

26. (canceled)
